(19) United States
(12) Patent Application Publication
(10) Pub. No.: US 2004/0196367 A1
(43) Pub. Date: Oct. 7, 2004

(54) Method and apparatus for performing reconnaissance, intelligence-gathering, and surveillance over a zone

(76) Inventors: Pierre Raymond, Heimsbrunn (FR); Volker Wegner, Binzen (DE); Wolfgang Knorr, Mullheim (DE)

Correspondence Address: HARNESS, DICKEY & PIERCE, P.L.C., P.O. BOX 828, BLOOMFIELD HILLS, MI, 48303, US

(21) Appl. No.: 10/643,205

(22) Filed: Aug. 18, 2003

(30) Foreign Application Priority Data
Aug. 21, 2002 (FR) 0210454

(51) Int. Cl. H04N 7/18

(52) U.S. Cl. 348/144; 348/143

(57) ABSTRACT

The apparatus for performing reconnaissance, intelligence-gathering and surveillance over a zone is of the type comprising means forming a projectile launcher, a projectile (1) equipped with a camera (2) and with an image transmitter circuit (4), and a receiver member for receiving the images transmitted in this way. The launcher-forming means are of a type in which they are individual, manually operated, and portable so that they can be carried by an individual person. The projectile (1) is of small or medium caliber. The receiver member comprises a viewing monitor and a receiver circuit, both of which are small in size so as to form a receiver member that is also individual, and portable. The apparatus can be used and transported by a person on his/her own.

### FIELD

The present invention relates to performing short-distance reconnaissance, intelligence-gathering, and surveillance over a zone.

### BACKGROUND

A general application of the present invention is to acquire information from a zone from a short distance away, and more particularly for observation and combat in an urban, semi-urban, or industrial zone. A particular application of the present invention is also to use in civil protection for observation and reconnaissance of a zone to which access is difficult. Reconnaissance systems are already known that are based on acquiring and processing images picked up and transmitted by a camera on board a projectile, and received remotely by a ground station.

In practice, a launcher, such as a 155 mm gun, launches a projectile over the zone to be observed. The projectile is equipped with an on-board camera, which is generally ruggedized to withstand the high acceleration to which it is subjected on board the projectile. A television station on the ground receives, via a communications relay, the images transmitted in this way by the projectile as it travels along its path to the target.

That type of system is well suited to long-distance observation in open country. Unfortunately, it does not solve the problem relating to short-distance observation in an urban zone, which is precisely when soldiers need information to determine, for example, whether allied or enemy troops are to be found on the other side of a building that is blocking their field of vision. In addition, because of the complex and cumbersome logistics involved, that type of system is not adapted to satisfying the criteria of flexibility, rapidity, and simplicity that are required for observation and combat in urban zones. Its cost is also too high for it to be distributed in large numbers.

In addition, in the field of civil protection, the problem arises of visually locating victims, even if they are quite close to the rescuers. In particular in the mountains or in other zones to which access is difficult (polluted or flooded zone).

### SUMMARY

The present invention solves these problems.

It provides an apparatus for performing reconnaissance, intelligence-gathering and surveillance over a zone, the apparatus being of the type comprising means forming a projectile launcher, a projectile equipped with a camera and with an image transmitter circuit, and a receiver member for receiving the images transmitted in this way. According to a general definition of the invention, the launcher-forming means are of a type in which they are individual, manually operated, and portable so that they can be carried by an individual person, the projectile is of a small or medium caliber, and the receiver member comprises a viewing monitor and a receiver circuit, both of which are small in size so as to form a receiver member that is also individual, and portable, so that the apparatus can be used and transported by a person on his/her own. Such apparatus is of very low cost, which makes it possible to distribute it on a large scale, to ground troops, for example.

The applicant has thus observed that with such launchers and receivers, of a type in which they are individual and portable so that they can be carried by an individual person such as a solider, rescue worker, or the like in association with a projectile, of a small or medium caliber, an apparatus for performing reconnaissance, intelligence-gathering, and surveillance over a zone can be set up by a person on his/her own and without any cumbersome or special logistics. Moreover, the apparatus of the invention makes it possible to watch the chosen zone immediately.

Preferably, the projectile has a caliber lying substantially in the range 12.7 mm to 60 mm, and typically it has a caliber of substantially 40 mm. According to another characteristic of the invention, the projectile is provided with means for stabilizing and/or slowing down its fall. According to one embodiment, the projectile is provided with guide means. However, the projectile does not necessarily comprise guide means. In an application to rescue work, for example, the projectile includes a compartment suitable for receiving an object.

Preferably, the camera is of CCD (Charge-Coupled Device), CMOS (Complementary Metal-Oxide Silicon), or some other like type.

Advantageously, the launcher-forming means are provided with means for protecting the hands of the user. The present invention also provides a method of performing reconnaissance, intelligence-gathering, and surveillance over a zone, which method is implemented by the apparatus of the invention. Provision may be made to retrieve the projectile after landing so as to re-use the on-board electronics.

### BRIEF DESCRIPTION OF THE DRAWINGS

Other characteristics and advantages of the invention will appear on reading the following detailed description and on examining the drawings, in which:

FIG. 1 diagrammatically shows a projectile of the invention as equipped with a parachute;

FIG. 2 diagrammatically shows component elements of the receiver member of the invention;

FIG. 3 is a longitudinal section view of a first embodiment of a projectile launcher in which the propellant charge is incorporated into the launch tube of the invention; and

FIG. 4 is a longitudinal section view of a second embodiment of a projectile launcher in which the propellant charge is integrated into the projectile of the invention.

### DETAILED DESCRIPTION

In FIG. 1, reference 1 designates a projectile launched by a self-contained, non-reusable, individual launcher that is operated manually and handheld by an individual person such as a soldier, a rescue worker, or the like. The projectile 1 is shown on the downward path going down towards the zone to be observed. As described in more detail below, the projectile 1 includes an on-board camera 2 housed in the nose of the projectile 1. For example, the camera is of the silicon CCD type, which is widely commercially available. A lens 3 is placed in front of the camera 2. The lens is made of a plastics material or of some other material. The camera 2 is connected electrically to a radiofrequency transmitter circuit E placed in a compartment 4. For example, the transmitter is of the ultra-high frequency (UHF) type for video.

Optionally, in particular for rescue applications, the projectile further includes a compartment 5 suitable for receiving an object O. For example, the object O may be a medicine, a communications terminal such as a mobile phone, or the like. In a military configuration, the object may be a charge of the explosive type. A compartment 6 is also provided for receiving batteries B serving to supply electrical energy to the camera 2 and to the transmitter circuit E. The projectile further includes a compartment 7 for receiving a parachute 9 (shown opened in FIG. 1).

Finally, the projectile may be equipped with guide and/or stabilizer elements 8 of the fin type. Although, it will be understood that any appropriate stabilizer or guide mechanism may be provided. In an embodiment that is not shown, the projectile is not equipped with such elements. The projectile 1 has a caliber substantially lying in the range 12.7 mm to 60 mm, and typically 40 mm.

The observation is of the short-distance type, e.g. for distances lying in the range 1 km to 5 km, or indeed a few hundred meters. Increasing the transmission range requires a powerful transmitter and therefore more powerful batteries, and thus results in apparatus of larger caliber.

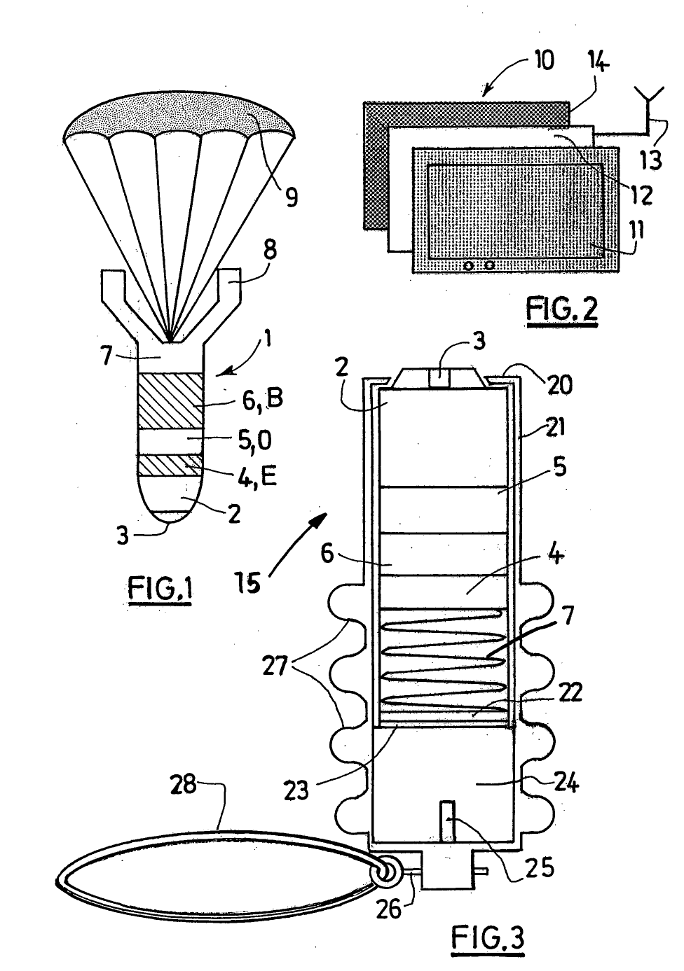

As shown in FIG. 2, the receiver member 10 which is suitable for receiving the images picked up and transmitted by the projectile is a self-contained, portable member that is simple to use. For example, the receiver member 10 comprises a viewing screen 11 of the Liquid Crystal Display (LCD) type or of the Thin Film Transistor (TFT) type having a size of about 150 mm×100 mm. The receiver member 10 is equipped with a UHF video receiver circuit 12 connected to an antenna 13. Since the receiver is advantageously self-contained, a compartment 14 for receiving a battery is provided. The weight of such a receiver member is less than 1 kg.

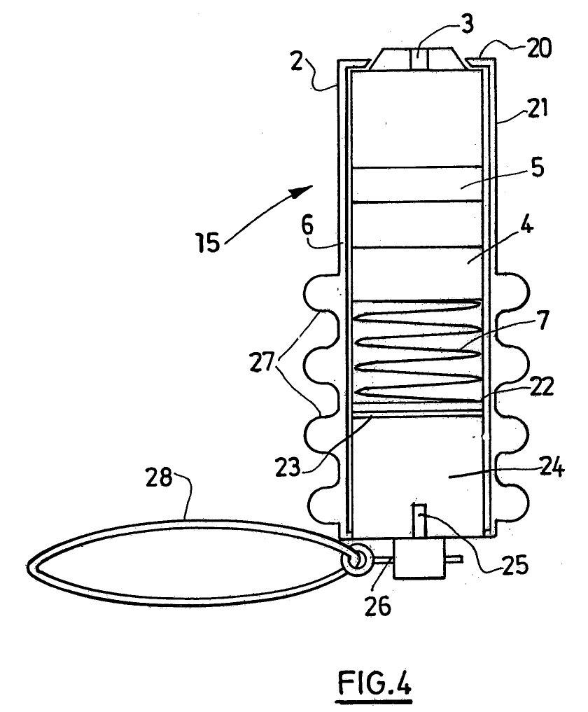

For example, the projectile launcher is of the grenade launcher, mortar, hand grenade, or distress flare type, or indeed of the bow and arrow or crossbow type (FIGS. 3 and 4). FIG. 3 shows the component elements of the projectile of the invention described with reference to FIG. 1 in association with an individual launcher 15 that is non-reusable, self-contained, manually operated, and handheld. The launcher 15 contains the projectile 1 with the camera 2 and its lens 3 disposed at the end of the nose of the projectile. The launcher 15 comprises a cover-forming sealing film 20, and a tube 21.

The compartments 4, 5, 6, and 7 for receiving respectively the transmitter/antenna circuit E, the optional object O, the batteries B, and the parachute 9 can be seen. A delayed pyrotechnics charge for extracting the parachute 9 is also received in the compartment 22 in the vicinity of the compartment 7 for receiving the parachute 9. It is possible to consider opening the parachute when the projectile starts its descent, by making advantageous use of the aerodynamic forces. Advantageously, a layer that forms thermal insulation 23 is provided between the compartment 22 and the propellant-type charge 24 which is designed to enable the sealing film 20 to be broken and to enable the projectile 1 of the invention to be sent to a certain altitude.

A trigger 25 is provided for triggering the pyrotechnics charge 24. Preferably, a safety element, e.g. of the safety pin type 26, is associated with the pyrotechnics charge 24. In this example, the pyrotechnics charge trigger 25 in association with the safety element 26 constitutes the firing mechanism whose shape and principle may be otherwise. Means forming a hand guide 27 and hand protection 28 are provided respectively around the tube 21 and in association with the pin 26 so as to protect the hand of the person launching the projectile.

FIG. 4 shows a variant of the launcher of the invention, in which variant the propellant charge 24 is integrated into the projectile of the invention.

The apparatus formed by the projectile launcher 15, by the projectile 1 and by the receiver member 10 makes it possible for intelligence-gathering, location, reconnaissance, and surveillance operations to be performed by people who have to operate in environments which are potentially dangerous, hostile or indeed inaccessible, and for which an overview in real time does not require any cumbersome or sophisticated logistics. The apparatus of the invention makes it possible to acquire information in urban, semi-urban, or industrial environments, or in inaccessible or indeed dangerous zones, from a short distance and in real time, and under optimum safety conditions. Such apparatus can serve to locate a person, and to supply location or communications equipment, medication or the like to them. The images picked up by the camera 2 are viewed directly on the video monitor 11. It is not necessary to process the information on transmission and on reception.

It will be understood that the entire apparatus, namely the projectile or rocket/flare, the projectile launcher, and the receiver member, is portable. The invention is applicable equally well both to civilian applications and to military applications.

The apparatus of the invention integrates a compartment 5 for transporting a payload (medication, location objects, communications objects, etc.). Advantageously, the items of equipment forming the on-board electronics are received in a compartment suitable for withstanding shocks, in particular by means for slowing down and/or stabilizing its fall, thereby enabling them to be retrieved. The launcher may be integrated into a carrier compatible with the chosen launcher, e.g. a distress flare launcher, a pyrotechnic pipe, a rifle, or a pistol. The apparatus may be such that the means forming a projectile launcher 15 are portable by a person not only when the person moves from one place to another, but also during the launching of the projectile 1. Thus, with the apparatus of the invention, it is possible to have the projectile launched by infantry using mechanical means of the grenade launcher or mortar type.

The projectile is stabilized by parachute as it falls. For use over short distances, the apparatus may be in the form of a hand grenade. With a firearm, a solider can launch a small or medium caliber projectile or a 40 mm grenade over the top of buildings. In a more sophisticated embodiment, the soldier could pilot the projectile 1.

The video images acquired are transmitted in real time onto a small LCD screen with which the soldier is equipped. For civil protection purposes, by means of the apparatus which is easy to carry and quick to use, it is possible for rescuers to fire over the zone to be observed. As it falls, the projectile 1 transmits a view of the zone in real time. The images received can be processed quickly, and optionally enlarged by conventional image-processing means. In addition, surveillance personnel for surveillance of land and of buildings may be equipped with the apparatus of the invention. Used remotely, in the event that an intrusion signal is triggered, it makes it possible to view the suspicious zone.

What is claimed is:

1. An apparatus for performing reconnaissance, intelligence-gathering and surveillance over a zone, the apparatus being of the type comprising means forming a projectile launcher, a projectile equipped with a camera and with an image transmitter circuit, and a receiver member for receiving the images transmitted in this way, said apparatus including the launcher-forming means are of a type that is individual, manually operated, and portable so that they can be carried by an individual person, in that the projectile is of small or medium caliber, and in that the receiver member comprises a viewing monitor and a receiver circuit, both of which are small in size so as to form a receiver member that is also individual, and portable, so that the apparatus can be used and transported by a person on his/her own.

2. The apparatus according to claim 1, when the receiver member and the transmitter circuit communicate in real time using a suitable communications mode and generally directly between said transmitter circuit and said receiver member.

3. The apparatus according to claim 1, wherein the projectile has a caliber that is generally about 12.7 mm to about 60 mm.

4. The apparatus according to claim 3, wherein the projectile has a caliber of substantially 40 mm.

5. The apparatus according to claim 1, wherein the projectile is provided with a means for at least one of stabilizing and slowing down its fall.

6. The apparatus according to claim 1, wherein the projectile is provided with a guide means.

7. The apparatus according to claim 1, wherein the projectile includes a compartment suitable for receiving an object of the type belonging to the group comprising a mobile telephone, a military charge, a medication, a provision, and combinations thereof.

8. The apparatus according to claim 1, wherein the camera is of a charge coupled device (CCD), complimentary metal-oxide silicon (CMOS), or digital.

9. The apparatus according to claim 1, wherein the launcher-forming means are provided with means for protecting the hands of the user.

10. The apparatus according to claim 1, wherein the means forming a projectile launcher are portable by a person during the launching of the projectile.

11. A method of performing reconnaissance, intelligence-gathering, and surveillance over a zone, which method is of the type comprising the following steps:
a) launching a projectile equipped with an on-board camera and with a transmitter circuit;
b) picking up images and transmitting the images picked up in this way; and
c) receiving the images and viewing them;
wherein said step a) is performed using launcher-forming means that are of a type that are individual, manually operated, and portable so that they can be carried by an individual person;
wherein said steps b) and c) are performed in real time; and
wherein said step c) is performed using a receiver member that is individual and portable;
wherein said steps a), b), and c) are able to be implemented by a person.

12. The method according to claim 11, further comprising:
d) providing a compartment suitable for receiving an object; and
e) taking said object on board.

13. The method according to claim 11, further comprising f) retrieving the projectile after landing so as to re-use at least certain elements of the apparatus.

14. An apparatus comprising:
a projectile launcher;
a projectile operably launched by said projectile launcher, the projectile including:
a camera operable to transmit an image through a first circuit; and
a receiver operably receiving images transmitted by said first circuit;
wherein the apparatus is substantially individually, manually operated, and portable so that it can be moved substantially by a single person;
wherein said receiver member is also substantially portable by a single person so that the single person can use and transport the apparatus.

15. The apparatus of claim 14, wherein the receiver includes:
a second circuit operably receiving the signal transmitted by the first circuit; and
a monitor operably displaying the signal received by the second circuit;
wherein the person is able to view the signal displayed on the monitor.

16. The apparatus of claim 14, wherein said first and second circuits communicate in real time in a substantially direct manner.

17. The apparatus of claim 14, wherein a caliber of the projectile is about 12.7 mm to about 60 mm.

18. The apparatus of claim 14, further comprising a stabilizing mechanism acting to at least one of: stabilize and slow down, a fall of said projectile after said projectile is launched from said projectile launcher.

19. The apparatus of claim 1, further comprising a guide mechanism operably guiding said projectile through a selected path.

20. The apparatus of claim 14, wherein said projectile includes a compartment suitable for receiving an object essentially selected from a group comprising:
a mobile telephone, a military charge, a medication, a provision, and combinations thereof.
